(19) United States
(12) Patent Application Publication
(10) Pub. No.: US 2023/0211430 A1
(43) Pub. Date: Jul. 6, 2023

(54) ELECTRICAL DISCHARGE MACHINE

(71) Applicant: FANUC CORPORATION, Yamanashi (JP)

(72) Inventors: Masahide YAMAOKA, Yamanashi-ken (JP); Meguru YAMAGUCHI, Yamanashi-ken (JP)

(21) Appl. No.: 17/928,329

(22) PCT Filed: Jun. 1, 2021
(86) PCT No.: PCT/JP2021/020806

§ 371 Date: Nov. 29, 2022

(30) Foreign Application Priority Data
Jun. 5, 2020 (JP) 2020-098122

(51) Int. Cl. B23H 7/02; B23H 7/20; B23Q 17/00; G05B 19/406

(52) U.S. Cl. CPC B23H 7/02; B23H 7/20; B23Q 17/00; G05B 19/406; B23H 2500/20

(57) ABSTRACT

An electrical discharge machine which is less likely to be used in a high risk state. This electrical discharge machine is provided with an intra-setting modification display control unit that, when a risk level corresponding to a setting content directed by a user is higher than or equal to an alert-causing threshold value, displays an intra-setting modification alert-causing display, and a post-setting modification display control unit that, if the state in which the risk level is higher than or equal to the alert threshold value continues, displays a post-setting modification alert-causing display at predetermined time intervals.

### TECHNICAL FIELD

The present invention relates to an electrical discharge machine.

### BACKGROUND ART

In JP 3856603 B2, a wire electrical discharge machine is disclosed that carries out machining on a workpiece by applying a pulse voltage to a machining gap between the wire electrode and the workpiece. An electrical discharge machine such as the above-described wire electrical discharge machine possesses various setting items. The electrical discharge machine operates based on setting contents that have been preset.

### SUMMARY OF THE INVENTION

However, in the case that the electrical discharge machine is used in a state in which a setting item has been changed to a setting content that differs from the recommended setting content, the electrical discharge machine itself or the machining of the object to be machined may be adversely affected.

An object of the present invention is to provide an electrical discharge machine which is capable of preventing the electrical discharge machine from being used in a high risk state.

An electrical discharge machine according to one aspect of the present invention is characterized by an electrical discharge machine including a controller configured to carry out electrical discharge machining on an object to be machined by generating an electrical discharge in a machining gap formed between the object to be machined and an electrode, the electrical discharge machine comprising a risk level storage unit configured to store risk levels corresponding to setting contents of various setting items of the controller, a first determination unit configured to determine, in a case that an instruction is given by a user to change a setting content of any one of a plurality of the setting items determined in advance to a setting content other than a recommended setting content, whether or not the risk level corresponding to the setting content instructed by the user is greater than or equal to a warning threshold based on the risk levels stored in the risk level storage unit, a setting change time display control unit configured to display, on a display unit, a setting change time warning display that is a warning display at a time of setting change, in a case that the first determination unit has determined that the risk level corresponding to the setting content instructed by the user is greater than or equal to the warning threshold, a second determination unit configured to determine, after the setting change time warning display is displayed, whether or not a state in which the risk level is greater than or equal to the warning threshold is continuing, and a post setting change display control unit configured to display, on the display unit and each time that a time interval determined in advance elapses, a post setting change warning display that is a warning display after the setting change has been made, in a case that the second determination unit has determined that the state in which the risk level is greater than or equal to the warning threshold is continuing.

According to the present invention, it is possible to provide an electrical discharge machine which is capable of preventing the electrical discharge machine from being used in a high risk state.

### BRIEF DESCRIPTION OF DRAWINGS

FIG. 1 is a perspective view showing an electrical discharge machine according to one embodiment;

FIG. 2 is a block diagram showing a portion of the electrical discharge machine according to the embodiment;

FIG. 3 is a diagram showing an example of setting items of a controller;

FIG. 4 is a diagram showing an example of a display screen of a display unit;

FIG. 5A and FIG. 5B are diagrams showing examples of display screens of the display unit;

FIG. 6 is a diagram showing an example of a setting change time warning display;

FIG. 7 is a diagram showing an example of a post setting change warning display;

FIG. 8 is a diagram showing an example of a list screen;

FIG. 9 is a diagram showing an example of the list screen;

FIG. 10 is a flowchart showing operations of the electrical discharge machine according to the embodiment; and

FIG. 11 is a block diagram showing a portion of an electrical discharge machine according to an exemplary modification of the embodiment.

### DETAILED DESCRIPTION OF THE INVENTION

A preferred embodiment of an electrical discharge machine according to the present invention will be presented and described in detail below with reference to the accompanying drawings.

### [One Embodiment]

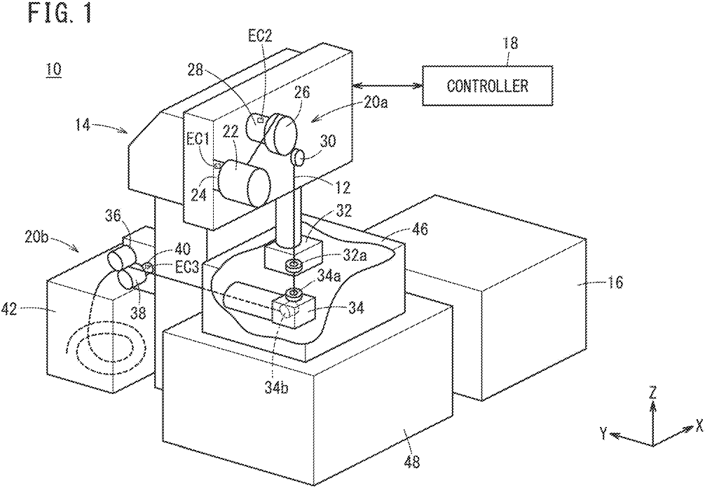

An electrical discharge machine according to one embodiment will be described with reference to the drawings. FIG. 1 is a perspective view showing an electrical discharge machine according to the present embodiment. In this instance, a case will be described as an example in which an electrical discharge machine 10 is a wire electrical discharge machine, but the electrical discharge machine 10 is not necessarily limited to being a wire electrical discharge machine.

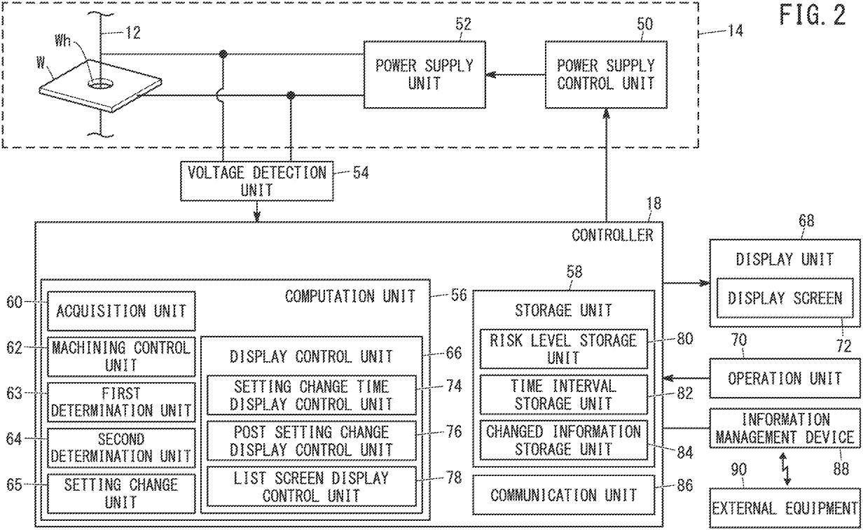

The electrical discharge machine 10, and specifically, the wire electrical discharge machine, is a machine tool that applies a voltage to an object to be machined W (see FIG. 2) and a wire electrode 12 in a dielectric working fluid, and generates an electrical discharge in a machining gap formed between the object to be machined W and the wire electrode 12, thereby carrying out electrical discharge machining on the object to be machined W. The electrical discharge machine 10 is equipped with a machine main body 14, a dielectric working fluid unit 16, and a controller 18.

The material of the wire electrode 12, for example, is a metal material such as a tungsten-based material, a copper alloy-based material, or a brass-based material. On the other hand, the material of the object to be machined W, for example, is a metal material such as an iron-based material or a super hard material (e.g., tungsten carbide).

The machine main body 14 is equipped with a supply system 20a and a recovery system 20b. The supply system 20a supplies the wire electrode (electrode) 12 toward the object to be machined (the workpiece) W. The recovery system 20b recovers the wire electrode 12 that has passed through the object to be machined W.

A wire bobbin 22, a torque motor 24, and a brake shoe 26 are provided in the supply system 20a. The wire electrode 12, which has not yet been used, is wound around the wire bobbin 22. The torque motor 24 applies a torque to the wire bobbin 22. The brake shoe 26 applies a braking force by friction to the wire electrode 12. A brake motor 28 and a wire guide (upper wire guide) 32 are further provided in the supply system 20a. The brake motor 28 applies a braking torque to the brake shoe 26. The wire guide 32 guides the wire electrode 12 above the object to be machined W. Encoders EC1 and EC2 for detecting a rotational position or a rotational speed are provided in the torque motor 24 and the brake motor 28, respectively. Based on detection signals detected by the encoders EC1 and EC2, the controller 18 is capable of feedback-controlling the torque motor 24 and the brake motor 28, in a manner so that the rotational speeds of the torque motor 24 and the brake motor 28 become predetermined rotational speeds. Moreover, the supply system 20a may further be equipped with a tension detector 30 that detects a magnitude of the tension of the wire electrode 12.

A wire guide (lower wire guide) 34, a pinch roller 36, and a feed roller 38 are provided in the recovery system 20b. The wire guide 34 guides the wire electrode 12 below the object to be machined W. The pinch roller 36 and the feed roller 38 are capable of sandwiching the wire electrode 12. The recovery system 20b is further equipped with a torque motor 40 that applies a torque to the feed roller 38. A recovery box 42 is further provided in the recovery system 20b. The used wire electrode 12 which has been conveyed using the pinch roller 36 and the feed roller 38 is recovered in the recovery box 42. An encoder EC3 for detecting a rotational position or a rotational speed is provided in the torque motor 40. Based on a detection signal detected by the encoder EC3, the controller 18 is capable of feedback-controlling the torque motor 40, in a manner so that the rotational speed of the torque motor 40 becomes a predetermined rotational speed.

The machine main body 14 is equipped with a work pan 46 in which the dielectric working fluid used at the time of electrical discharge machining can be stored. The dielectric working fluid is deionized water, oil, or the like. The work pan 46 is placed on a base portion 48. The wire guides 32 and 34 are arranged inside the work pan 46. The object to be machined W is disposed between the wire guide 32 and the wire guide 34. Die guides 32a and 34a that support the wire electrode 12 are provided respectively in the wire guides 32 and 34. In addition, a guide roller 34b is further provided in the wire guide 34. The guide roller 34b guides the wire electrode 12 to the pinch roller 36 and the feed roller 38 while changing the orientation of the wire electrode 12.

Moreover, the wire guide 32 ejects a clean dielectric working fluid that does not contain any machining waste (sludge) toward the machining gap formed between the wire electrode 12 and the object W to be machined. Consequently, the machining gap can be filled with the clean dielectric working fluid suitable for electrical discharge machining, and it is possible to prevent the accuracy of the electrical discharge machining from being lowered due to sludge generated by the electrical discharge machining. Further, the wire guide 34 may also eject the clean dielectric working fluid that does not contain any sludge toward the machining gap.

The object to be machined W is supported by a non-illustrated table that is movable in the X and Y directions. The wire guides 32 and 34, the object to be machined W, and the table are immersed in the dielectric working fluid that is stored in the work pan 46.

In the case that a start hole, which serves as a start point for the electrical discharge machining, is formed in the object to be machined W, the wire electrode 12 is inserted through the start hole, and the wire electrode 12 is connected. In such a case, a gap between the start hole of the object to be machined W and the wire electrode 12 becomes the machining gap. Further, in the case that a machined groove, which serves as a start point for the electrical discharge machining, is formed in the object to be machined W, the wire electrode 12 is inserted through the machined groove, and the wire electrode 12 is connected. In such a case, a gap between the machined groove and the wire electrode 12 becomes the machining gap. In such a case, after the wire electrode 12 has been inserted through the start hole or the machined groove of the object to be machined W and connected, the electrical discharge machine 10 causes the table (and the object to be machined W) to be moved in a plane parallel to the XY plane, while feeding out the wire electrode 12 in a downward direction (the -Z direction) toward the object to be machined W. As a result, machining is carried out on the object to be machined W. The phrase “connection of the wire electrode 12” implies that the wire electrode 12 that is wound around the wire bobbin 22 is passed through the wire guide 32, the object to be machined W, and the wire guide 34, and is sandwiched by the pinch roller 36 and the feed roller 38. In the case that the wire electrode 12 is connected, a predetermined amount of tension is applied to the wire electrode 12. It should be noted that the X direction and the Y direction are perpendicular to each other, and the direction perpendicular to the XY plane (the horizontal plane) is defined as a Z direction. It should be noted that the start hole or the machined groove that serves as the start point of the electrical discharge machining is not limited to being formed in the object to be machined W. For example, there may also be a case in which the machining is initiated from an end surface of the object to be machined W. Specifically, there may be a case in which cutting is initiated from the end surface of the object to be machined W. In such a case, the machining can be initiated from the end surface of the object to be machined W, without inserting the wire electrode 12 through the start hole or the machined groove.

The dielectric working fluid unit 16 is a unit that removes machining waste generated in the work pan 46 and controls the quality of the dielectric working fluid by adjusting the resistivity (the electrical resistivity), the temperature, and the like. The dielectric working fluid, the fluid quality of which is controlled by the dielectric working fluid unit 16, is returned again to the work pan 46, and the dielectric working fluid is ejected from at least the wire guide 32. The controller 18 is capable of controlling the machine main body 14 and the dielectric working fluid unit 16.

FIG. 2 is a block diagram showing a portion of the electrical discharge machine according to the present embodiment.

As shown in FIG. 2, the machine main body 14 is equipped with a power supply control unit 50, and a power supply unit 52. Moreover, as was described previously with reference to FIG. 1, the machine main body 14 is equipped with constituent elements other than these constituent elements, although only a portion of the constituent elements are shown in FIG. 2.

The power supply control unit 50 controls the power supply unit 52, in a manner so that the voltage is repeatedly applied at predetermined intervals to the object to be machined W and the wire electrode 12. More specifically, based on information supplied from the controller 18, the power supply control unit 50 determines the application conditions, such as a voltage value, a pulse width, and the pulse interval of voltage pulses to be applied. Upon having determined the application conditions, the power supply control unit 50 generates a drive pulse signal for driving the power supply unit 52, in a manner so as to apply the voltage under the determined application conditions, and then outputs the generated drive pulse signal to the power supply unit 52.

Based on the drive pulse signal, the power supply unit 52 repeatedly applies the voltage pulses to the object to be machined W and the wire electrode 12 at predetermined intervals. In FIG. 2, a state is illustrated in which a start hole Wh is formed in the object to be machined W, and the wire electrode 12 is inserted through the start hole Wh.

The electrical discharge machine 10 is further equipped with a voltage detection unit 54. The voltage detection unit 54 is capable of detecting the voltage in the machining gap (the machining gap voltage). Information indicative of the machining gap voltage as detected by the voltage detection unit 54 can be supplied to the controller 18.

The controller 18 controls the electrical discharge machine 10 as a whole. The controller 18 is equipped with a computation unit 56, a storage unit 58, and a communication unit 86. The computation unit 56 may be constituted, for example, by a processor such as a CPU (Central Processing Unit), but the present invention is not limited to this feature. In the storage unit 58, for example, a non-illustrated volatile memory and a non-illustrated nonvolatile memory are provided. As the volatile memory, there may be cited, for example, a RAM (Random Access Memory). As the nonvolatile memory, there may be cited, for example, a ROM (Read Only Memory) and a flash memory. Programs, data, and tables, etc., may be stored in the storage unit 58. The communication unit 86 serves to carry out communications with an information management device 88 or the like, which will be described later.

An acquisition unit 60, a machining control unit 62, a first determination unit 63, a second determination unit 64, a setting change unit 65, and a display control unit 66 are provided in the computation unit 56. The acquisition unit 60, the machining control unit 62, the first determination unit 63, the second determination unit 64, the setting change unit 65, and the display control unit 66 can be realized by programs that are stored in the storage unit 58 being executed by the computation unit 56.

The acquisition unit 60 is capable of acquiring information or the like supplied from the voltage detection unit 54 or the like. The information acquired by the acquisition unit 60 can be supplied to the machining control unit 62 and the like.

The machining control unit 62 appropriately controls the power supply control unit 50 and the like based on the information acquired by the acquisition unit 60, the setting content that has been preset, and the like, to carry out the electrical discharge machining on the object to be machined W.

The electrical discharge machine 10 is further equipped with a display unit 68 and an operation unit 70.

The display unit (display device) 68 may be constituted, for example, by a liquid crystal display or the like, but the present invention is not limited to this feature. The display unit 68 is equipped with a display screen 72.

The operation unit 70 may be constituted, for example, by a touch panel, a keyboard, a mouse, or the like, none of which are shown. The touch panel can be provided on the display screen 72 of the display unit 68. A user can provide instructions to the controller 18 by operating the operation unit 70. The user, for example, by operating the touch panel, the mouse, or the like, is capable of selecting a menu button, an icon, or the like.

The display control unit 66 is capable of controlling a display on the display unit 68. The display control unit 66 is equipped with a setting change time display control unit 74, a post setting change display control unit 76, and a list screen display control unit 78.

Various setting items are set in the controller 18. The setting items are preferably set to the recommended setting content, which is the setting content recommended by the manufacturer of the electrical discharge machine 10. However, the user may change the setting content of the setting item to a setting content other than the recommended setting content. In the case that the electrical discharge machine 10 is used in a state in which the setting content of the setting item is changed to a setting content other than the recommended setting content, an adverse effect may be imparted to the electrical discharge machine 10 itself, or an adverse effect may be imparted to the object to be machined W. Thus, according to the present embodiment, in the case that a setting change that increases the risk is performed, as will be described later, a warning display is made, and in addition, in the case that the high risk state continues, as will be described later, the warning display is repeated.

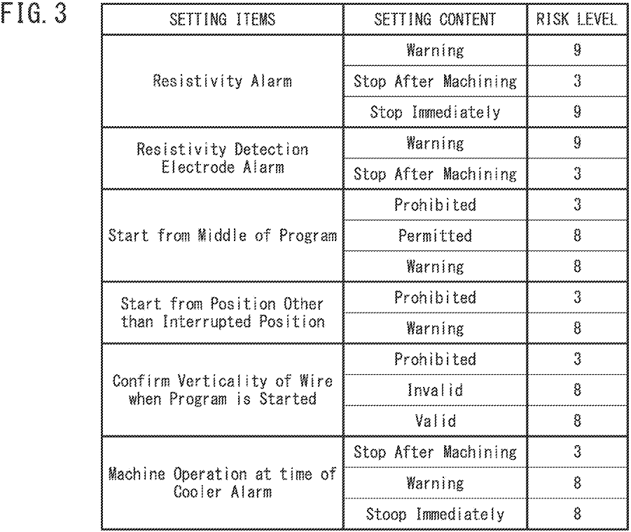

FIG. 3 is a diagram showing an example of setting items of the controller. A portion of the various setting items of the controller 18 are shown in FIG. 3. Setting items related to “machine operations at the time of an alarm” are shown in FIG. 3. More specifically, the setting items related to the alarms are shown in FIG. 3.

As shown in FIG. 3, for example, there is a setting item “resistivity alarm”. The setting item “resistivity alarm” is a setting item related to an operation of the electrical discharge machine 10 when a resistivity alarm is issued. The resistivity alarm is an alarm issued when the resistivity of the dielectric working fluid has fallen outside of a recommended range. The recommended value for the resistivity (the electrical resistivity) of the dielectric working fluid, for example, is on the order of 70000 Ω·cm. When the resistivity of the dielectric working fluid is lowered excessively relative to the recommended value, there is a concern that the machining of the object to be machined W may become unstable, or the accuracy of the machining dimensions may be lowered. The resistivity value of the dielectric working fluid can be adjusted by the dielectric working fluid unit 16. The dielectric working fluid unit 16 adjusts the resistivity value of the dielectric working fluid, for example, using a non-illustrated ion-exchange resin or the like. When the ion exchange resin deteriorates, it becomes difficult for the dielectric working fluid unit 16 to adjust the resistivity of the dielectric working fluid to lie within the recommended range. In order to maintain the resistivity of the dielectric working fluid within the recommended range, it is necessary to appropriately replace the ion exchange resin. As shown in FIG. 3, the setting content of the setting item “resistivity alarm” includes, for example, “warning”, “stop after machining”, and “stop immediately”. “Stop after machining” is the initial value of this setting item. In other words, “stop after machining” is the recommended setting content of this setting item. In the case that the resistivity of the dielectric working fluid no longer lies within the recommended range in a state in which the setting item is set to “stop after machining”, the operation of the electrical discharge machine 10 is stopped at a stage when the machining of the object to be machined W that is currently being machined is completed. It is not recommended to change the setting item from “stop after machining” to “warning” or “stop immediately”. However, the setting content of the setting item may be changed by the user to “warning” or “stop immediately”. In the case that the setting item is changed to “warning”, then even though a warning is issued when the resistivity of the dielectric working fluid has become outside of the recommended range, the electrical discharge machine 10 may continue to be used even after the electrical discharge machining of the object to be machined W is completed. More specifically, in such a case, after the machining of the object to be machined W that is currently being machined is completed, the electrical discharge machine 10 can further carry out machining on another object to be machined. In the case that the electrical discharge machine 10 continues to be used even though the resistivity of the dielectric working fluid lies outside of the recommended range, there is a concern that an adverse effect may be imparted to the electrical discharge machine 10 itself. More specifically, in such a case, there is a concern that the electrical discharge machine 10 may be adversely affected. Further, in the case that the electrical discharge machine 10 continues to be used even though the resistivity of the dielectric working fluid lies outside of the recommended range, there is a concern that the machining of the object to be machined W may become unstable, and the accuracy of the machining dimensions may be lowered. More specifically, in such a case, there is a concern that an adverse effect may be imparted to the machining of the object to be machined W. The risk level in the case that the setting item is changed to “warning”, for example as shown in FIG. 3, is set to 9. Moreover, the risk level is comprehensively determined, based on the risk of an adverse effect being imparted to the electrical discharge machine 10 itself, the risk of an adverse effect being imparted to the machining of the object to be machined W, and the like. In the case that the setting item is changed to “stop immediately”, the electrical discharge machine 10 is stopped immediately when the resistivity of the dielectric working fluid has fallen outside of the recommended range. In the case that the electrical discharge machine 10 is stopped immediately even though the object to be machined W is currently being machined, there is a concern that a satisfactory product cannot be obtained. The risk level in the case that the setting item is changed to “stop immediately”, for example as shown in FIG. 3, is set to 9. It should be noted that the risk level in the case that the setting item is set to “stop after machining”, for example as shown in FIG. 3, is set to 3.

As shown in FIG. 3, for example, there is a setting item “resistivity detection electrode alarm”. The setting item “resistivity detection electrode alarm” is a setting item related to an operation of the electrical discharge machine 10 when a resistivity detection electrode alarm is issued. The resistivity detection electrode alarm is an alarm that is issued when a maintenance deadline, which is a deadline for maintenance of a resistivity detection electrode, which is an electrode for detecting the resistivity of the dielectric working fluid, has expired. The maintenance of the resistivity detection electrode, for example, involves cleaning of the resistivity detection electrode, but the present invention is not limited to this feature. The maintenance deadline for the resistivity detection electrode, for example, is one month, but the present invention is not limited to this feature. As shown in FIG. 3, the setting content of the setting item “resistivity detection electrode alarm” includes, for example, “warning” and “stop after machining”. “Stop after machining” is the initial value of this setting item. In other words, “stop after machining” is the recommended setting content of this setting item. In the case that the maintenance deadline for the resistivity detection electrode has expired in a state in which the setting item is set to “stop after machining”, the operation of the electrical discharge machine 10 is stopped at a stage when the machining of the object to be machined W that is currently being machined is completed. It is not recommended to change the setting item from “stop after machining” to “warning”. However, the setting content of the setting item may be changed by the user to “warning”. In the case that the setting item is changed to “warning”, then even though a warning is issued when the maintenance deadline for the resistivity detection electrode has expired, the electrical discharge machine 10 may continue to be used even after the electrical discharge machining of the object to be machined W is completed. More specifically, in such a case, after the machining of the object to be machined W that is currently being machined is completed, the electrical discharge machine 10 can further carry out machining on another object to be machined W. In the case that the electrical discharge machine 10 continues to be used even though the maintenance deadline for the resistivity detection electrode has expired, then there is a concern that, even if the resistivity of the dielectric working fluid has fallen outside of the recommended range, the resistivity of the dielectric working fluid having fallen outside of the recommended range may not be detected, and an adverse effect may be imparted to the electrical discharge machine 10 itself. More specifically, in such a case, there is a concern that the electrical discharge machine 10 may be adversely affected. Further, in the case that the electrical discharge machine 10 continues to be used even though the maintenance deadline for the resistivity detection electrode has expired, then there is a concern that, even if the resistivity of the dielectric working fluid has fallen outside of the recommended range, the resistivity of the dielectric working fluid having fallen outside of the recommended range may not be detected, and the machining of the object to be machined W may become unstable, or the accuracy of the machining dimensions may be lowered. More specifically, in such a case, there is a concern that an adverse effect may be imparted to the machining of the object to be machined W. The risk level in the case that the setting item is changed to “warning”, for example as shown in FIG. 3, is set to 9. It should be noted that the risk level in the case that the setting item is set to “stop after machining”, for example as shown in FIG. 3, is set to 3.

As shown in FIG. 3, there is a setting item “start from middle of program”. The setting item “start from middle of program” is a setting item related to an operation of the electrical discharge machine 10 when a non-illustrated start key is pressed in a state in which a cursor is positioned at a position other than the beginning of the program. The start key serves to initiate electrical discharge machining by the electrical discharge machine 10. The start key may be a mechanical switch or the like, or may be displayed on the display screen 72 of the display unit 68. The program is a program used in order to carry out machining on the object to be machined W, and more specifically, is a program for instructing linear movement, curved movement, ON/OFF of the electrical discharge, and the like. Normally, when the start key is pressed in a state in which the cursor is positioned at the beginning of the program displayed on the display screen 72 of the display unit 68, the electrical discharge machining of the workpiece W is initiated. In the case that the electrical discharge machining is initiated in a state in which the cursor is positioned at a position other than the beginning of the program, the portion of the program positioned before the position of the cursor will not be executed, and only the portion of the program located after the position of the cursor is executed. Therefore, in such a case, it is not possible to correctly perform machining on the object to be machined W. As shown in FIG. 3, the setting content of the setting item “start from middle of program” includes, for example, “prohibited”, “permitted”, and “warning”. “Prohibited” is the initial value of this setting item. In other words, “prohibited” is the recommended setting content of this setting item. In the case that the setting item is set to “prohibited”, the electrical discharge machine 10 does not initiate the electrical discharge machining, even if the start key is pressed in a state in which the cursor is positioned at a position other than the beginning of the program. It is not recommended to change the setting item from “prohibited” to “permitted” or to “warning”. However, the setting content of the setting item may be changed by the user to “permitted” or to “warning”. In the case that the setting item is set to “permitted”, the electrical discharge machine 10 executes the electrical discharge machining, when the start key is pressed in a state in which the cursor is positioned at a position other than the beginning of the program. In the case that the electrical discharge machining is executed by the electrical discharge machine 10 in a state in which the cursor is positioned at a position other than the beginning of the program, there is a concern that the electrical discharge machine 10 may operate abnormally, or that the object to be machined W may be machined into an unintended shape. The risk level in the case that the setting item is changed to “permitted”, for example as shown in FIG. 3, is set to 8. In the case that the setting item is set to “warning”, when the start key is pressed in a state in which the cursor is positioned at a position other than the beginning of the program, a warning is issued, and when the start key is pressed again, the electrical discharge machine 10 executes the electrical discharge machining. In the case that the electrical discharge machining is initiated by the electrical discharge machine 10 in a state in which the cursor is positioned at a position other than the beginning of the program, there is a concern that the electrical discharge machine 10 may operate abnormally, or that the object to be machined W may be machined into an unintended shape. The risk level in the case that the setting item is changed to “warning”, for example as shown in FIG. 3, is set to 8. It should be noted that the risk level in the case that the setting item is set to “prohibited”, for example as shown in FIG. 3, is set to 3.

As shown in FIG. 3, there is a setting item “start from position other than interrupted position”. The setting item “start from position other than interrupted position” is a setting item related to restarting the electrical discharge machining in the case that the start key is pressed in a state in which a position other than the machining interrupted position is the machining restarting position. The machining interrupted position, i.e., the point at which machining is interrupted, is a position at which the electrical discharge machining is interrupted. The machining restarting position is the position at which machining is restarted. As shown in FIG. 3, the setting content of the setting item “start from position other than interrupted position” includes, for example, “prohibited” and “warning”. “Prohibited” is the initial value of this setting item. In other words, “prohibited” is the recommended setting content of this setting item. In the case that the setting item is set to “prohibited”, even if the start key is pressed in a state in which a position other than the machining interrupted position is the machining restarting position, restarting of the electrical discharge machining is not carried out. It is not recommended to change the setting item from “prohibited” to “warning”. However, the setting content of the setting item may be changed by the user to “warning”. In the case that the setting item is changed to “warning”, when the start key is pressed in a state in which the position other than the machining interrupted position is the machining restarting position, a warning is issued, and when the start key is pressed again, the electrical discharge machining is restarted from the position other than the machining interrupted position. In the case that the electrical discharge machining is restarted from the position other than the machining interrupted position, there is a concern that the electrical discharge machine 10 may operate abnormally, or that the object to be machined W may be machined into an unintended shape. The risk level in the case that the setting item is changed to “warning”, for example as shown in FIG. 3, is set to 8. It should be noted that the risk level in the case that the setting item is set to “prohibited”, for example as shown in FIG. 3, is set to 3.

As shown in FIG. 3, there is a setting item “confirm verticality of wire when program is started”. The setting item “confirm verticality of wire when program is started” is a setting item related to confirming whether or not the wire electrode 12 is positioned in a vertical position that has been registered in advance as an initial position. Such a confirmation is carried out when the program is initiated. When the program is initiated, the position of the wire electrode 12 is preferably in the vertical position that has been registered in advance as the initial position. More specifically, when the program is initiated, it is preferable that the direction in which the wire electrode 12 is stretched corresponds to the vertical position that has been registered in advance as the initial position. For example, in the case that the longitudinal direction of a predetermined portion of the wire electrode 12 lies in the Z direction, it can be determined that the wire electrode 12 is positioned in the vertical position, but the present invention is not limited to this feature. In the case that the machining is initiated in a state in which the wire electrode 12 is not positioned in the vertical position, there is a concern that the electrical discharge machine 10 may operate abnormally, or that the object to be machined W may be machined into an unintended shape. It should be noted that, depending on the content of the machining, there may also be situations in which, after machining has been initiated, the wire electrode 12 is inclined and machining is carried out on the object to be machined W. As shown in FIG. 3, the setting content of the setting item “confirm verticality of wire when program is started” includes, for example, “prohibited”, “invalid”, and “valid”. “Prohibited” is the initial value of this setting item. In other words, “prohibited” is the recommended setting content of this setting item. In the case that the setting item is set to “prohibited”, then when the start key is pressed, a check is performed as to whether or not the wire electrode 12 is positioned in the vertical position. In the case that the wire electrode 12 is not positioned in the vertical position, the electrical discharge machining by the electrical discharge machine 10 is prohibited. It is not recommended to change the setting item from “prohibited” to “valid” or to “invalid”. However, the setting content of the setting item may be changed by the user to “valid” or to “invalid”. In the case that the setting item is changed to “valid”, then when the start key is pressed, a check is performed as to whether or not the wire electrode 12 is positioned in the vertical position. In the case that the wire electrode 12 is not positioned in the vertical position, a warning is issued, and when the start key is pressed again, the electrical discharge machine 10 executes the electrical discharge machining. In the case that the electrical discharge machining is executed by the electrical discharge machine 10 even though the wire electrode 12 is not positioned in the vertical position, there is a concern that the electrical discharge machine 10 may operate abnormally, or that the object to be machined W may be machined into an unintended shape. The risk level in the case that the setting item is changed to “valid”, for example as shown in FIG. 3, is set to 8. In the case that the setting item is changed to “invalid”, then when the start key is pressed, a check is not performed as to whether or not the wire electrode 12 is positioned in the vertical position. Since the check as to whether or not the wire electrode 12 is positioned in the vertical position is not performed, the electrical discharge machining may be initiated by the electrical discharge machine 10 in a state in which the wire electrode 12 is not positioned in the vertical position. In the case that the electrical discharge machining is initiated by the electrical discharge machine 10 in a state in which the wire electrode 12 is not positioned in the vertical position, there is a concern that the electrical discharge machine 10 may operate abnormally, or that the object to be machined W may be machined into an unintended shape. The risk level in the case that the setting item is changed to “invalid”, for example as shown in FIG. 3, is set to 8. It should be noted that the risk level in the case that the setting item is set to “prohibited”, for example as shown in FIG. 3, is set to 3.

As shown in FIG. 3, there is a setting item “machine operation at time of cooler alarm”. The setting item “machine operation at time of cooler alarm” is a setting item related to an operation of the electrical discharge machine 10 when a cooler alarm is issued. The cooler alarm is an alarm issued when a malfunction occurs in a cooler for cooling the dielectric working fluid. As shown in FIG. 3, the setting content of the setting item “machine operation at time of cooler alarm” includes, for example, “stop after machining”, “warning”, and “stop immediately”. “Stop after machining” is the initial value of this setting item. In other words, “stop after machining” is the recommended setting content of this setting item. In the case that the cooler alarm is issued in a state in which the setting item is set to “stop after machining”, the operation of the electrical discharge machine 10 is stopped at a stage when the machining of the object to be machined W that is currently being machined is completed. It is not recommended to change the setting item from “stop after machining” to “warning” or “stop immediately”. However, the setting content of the setting item may be changed by the user to “warning” or “stop immediately”. In the case that the setting item is changed to “warning”, then even though a warning is issued when the cooler alarm is issued, the electrical discharge machine 10 may continue to be used even after the electrical discharge machining of the object to be machined W is completed. In the case that the cooler alarm is issued, there is a concern that the temperature of the dielectric working fluid may become outside of the recommended range. In the case that the electrical discharge machining is executed by the electrical discharge machine 10 even though the temperature of the dielectric working fluid is outside of the recommended range, there is a concern that the accuracy of the machining dimensions will be extremely reduced. More specifically, in such a case, there is a concern that an adverse effect may be imparted to the machining of the object to be machined W. The risk level in the case that the setting item is changed to “warning”, for example as shown in FIG. 3, is set to 8. In the case that the setting item is changed to “stop immediately”, the electrical discharge machine 10 is stopped immediately when the cooler alarm is issued. In the case that the electrical discharge machine 10 is stopped immediately even though the object to be machined W is currently being machined, there is a concern that a satisfactory product cannot be obtained. The risk level in the case that the setting item is changed to “stop immediately”, for example as shown in FIG. 3, is set to 8. It should be noted that the risk level in the case that the setting item is set to “stop after machining”, for example as shown in FIG. 3, is set to 3.

As the setting items related to “machine operations at the time of an alarm”, there are setting items other than those described above; however, in order to simplify the explanation, such other setting items have been omitted herein. Further, setting items other than the setting items related to “machine operations at the time of an alarm” are also set in the controller 18; however in order to simplify the explanation, such other setting items have been omitted herein.

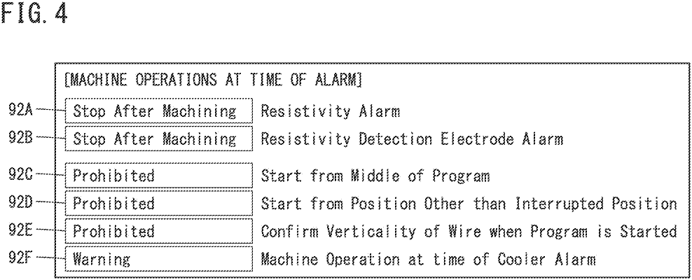

FIG. 4 is a diagram showing an example of the display screen of the display unit. A portion of the display screen 72 of the display unit 68 is shown in FIG. 4. A portion of the setting items related to “machine operations at the time of an alarm” are shown in FIG. 4.

The current setting contents of the respective setting items are displayed in input boxes 92A to 92F. The input box 92A is an input box related to the setting item “resistivity alarm”. The input box 92B is an input box related to the setting item “resistivity detection electrode alarm”. The input box 92C is an input box related to the setting item “start from middle of program”. The input box 92D is an input box related to the setting item “start from position other than interrupted position”. The input box 92E is an input box related to the setting item “confirm verticality of wire when program is started”. The input box 92F is an input box related to the setting item “machine operation at time of cooler alarm”.

In FIG. 4, an example is shown of a case in which the setting contents of the setting items “resistivity alarm” and “resistivity detection electrode alarm” are set respectively to “stop after machining”. Further, in FIG. 4, an example is shown of a case in which the setting contents of the setting items “start from middle of program”, “start from position other than interrupted position”, and “confirm verticality of wire when program is started” are set respectively to “prohibited”. Further, in FIG. 4, an example is shown of a case in which the setting content of the setting item “machine operation at time of cooler alarm” is set to “warning”. The reference numeral 92 is used when describing the input boxes in general, and the reference numerals 92A to 92F are used when describing the individual input boxes.

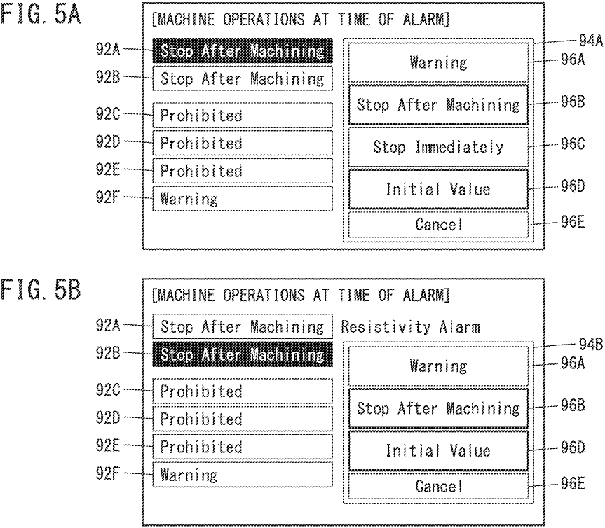

FIG. 5A and FIG. 5B are diagrams showing examples of display screens of the display unit. In FIG. 5A and FIG. 5B, examples are shown of the displays when the setting content is changed.

In FIG. 5A, an example is shown of a case in which the input box 92A related to the setting item “resistivity alarm” is selected by the user. When the input box 92A is selected by the user, then as shown in FIG. 5A, a selection menu 94A is displayed. The selection menu 94A includes, for example, a warning button 96A, a stop after machining button 96B, a stop immediately button 96C, an initial value button 96D, and a cancel button 96E. The reference numeral 96 is used when describing the buttons in general, and the reference numerals 96A to 96E are used when describing the individual buttons. The user can change the setting contents or the like by appropriately selecting any one of the buttons 96. As discussed previously, the initial value of the setting item “resistivity alarm” is “stop after machining”. Accordingly, in the case that the stop after machining button 96B is selected, a state in which the initial value button 96D is also selected is displayed. Further, in the case that the initial value button 96D is selected, the stop after machining button 96B is also selected. More specifically, in the example shown in FIG. 5A, the stop after machining button 96B and the initial value button 96D are linked to each other. Moreover, in FIG. 5A and FIG. 5B, the selected buttons 96 are indicated by bold lines.

In FIG. 5B, an example is shown of a case in which the input box 92B related to the setting item “resistivity detection electrode alarm” is selected by the user. When the input box 92B is selected by the user, then as shown in FIG. 5B, a selection menu 94B is displayed. The selection menu 94B includes the warning button 96A, the stop after machining button 96B, the initial value button 96D, and the cancel button 96E. As discussed previously, the initial value of the setting item “resistivity detection electrode alarm” is “stop after machining”. Accordingly, in the case that the stop after machining button 96B is selected, a state in which the initial value button 96D is also selected is displayed. Further, in the case that the initial value button 96D is selected, the stop after machining button 96B is also selected. More specifically, in the example shown in FIG. 5B, the stop after machining button 96B and the initial value button 96D are linked to each other.

As shown in FIG. 2, the storage unit 58 is equipped with a risk level storage unit 80, a time interval storage unit 82, and a changed information storage unit 84.

The risk level storage unit 80 is capable of storing risk levels (see FIG. 3) corresponding to the setting contents of the various setting items of the controller 18. As discussed previously, such risk levels are comprehensively determined, based on the risk of an adverse effect being imparted to the electrical discharge machine 10, and the risk of an adverse effect being imparted to the machining of the object to be machined W.

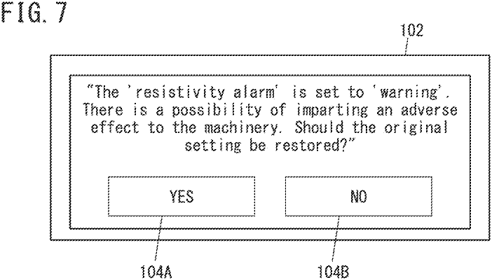

The time interval storage unit 82 is capable of storing a time interval for performing a post setting change warning display 102 (see FIG. 7), which will be described later. It should be noted that the time interval may be a time interval that does not correspond to the risk level, or may be a time interval that corresponds to the risk level. In the case that the time interval is a time interval that does not correspond to the risk level, the time interval can be set to a uniform value for all of the risk levels. On the other hand, in the case that the time interval is a time interval that corresponds to the risk level, the value of the time interval can be set to a smaller value as the risk level becomes greater.

In the changed information storage unit 84, information can be stored that is indicative of the time of the setting change, the setting item for which the setting change has been performed, and the content of the setting change. More specifically, a change history can be stored in the changed information storage unit 84.

In the case that an instruction is given by the user to change the setting content of any one of a plurality of setting items determined in advance to a setting content other than the recommended setting content, the first determination unit 63 makes the following determination. More specifically, in such a case, the first determination unit 63 determines whether or not the risk level corresponding to the setting content instructed by the user is greater than or equal to the warning threshold, based on the risk level corresponding to the setting content of the setting item. The warning threshold can be set to 7, for example, but the present invention is not limited to this feature.

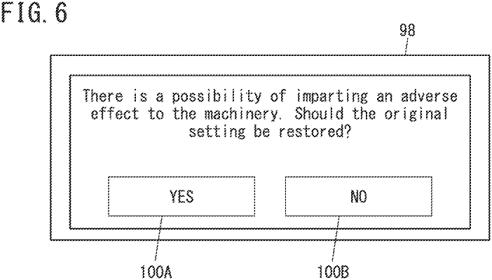

In the case it is determined by the first determination unit 63 that the risk level corresponding to the setting content instructed by the user is greater than or equal to the warning threshold, the setting change time display control unit 74 displays a setting change time warning display 98 as shown in FIG. 6 on the display screen 72 of the display unit 68. FIG. 6 is a diagram showing an example of the setting change time warning display. The setting change time warning display 98 is a warning display at the time of setting change. As shown in FIG. 6, the setting change time warning display 98 may be made up from a pop-up screen, for example, but the present invention is not limited to this feature. In FIG. 6, an example is shown of a case in which a message, “There is a possibility of imparting an adverse effect to the machinery. Should the original setting be restored?” is displayed in a pop-up screen. The pop-up screen that makes up the setting change time warning display 98 may include, for example, a YES button 100A on which “YES” is displayed, and a NO button 100B on which “NO” is displayed. In the case that the user has selected the YES button 100A, the original setting is restored. In other words, in the case that the user has selected the YES button 100A, the initial value is restored. In such a case, the setting change unit 65 does not change the setting content of the setting item. In the case that the user has selected the NO button 100B, the setting content of the setting item is changed. More specifically, in such a case, the setting change unit 65 changes the setting content of the setting item based on the instruction given by the user. Moreover, in this instance, an example is shown of a case in which “There is a possibility of imparting an adverse effect to the machinery”, but the present invention is not limited to this feature. In the case that there is a concern that not only the electrical discharge machine 10 itself but, also the machining of the object to be machined W may be adversely affected, for example, the phrase “There is a possibility of imparting an adverse effect to the machinery and the machining” may be displayed. In the case that there is no concern of imparting an adverse effect to the electrical discharge machine 10, but there is a concern of imparting an adverse effect to the machining of the object to be machined W, the phrase “There is a possibility of imparting an adverse effect to the machining” may be displayed.

After the setting change time warning display is displayed, the second determination unit 64 determines whether or not a state in which the risk level is greater than or equal to the warning threshold is continuing.

In the case it is determined by the second determination unit 64 that the state in which the risk level is greater than or equal to the warning threshold is continuing, the post setting change display control unit 76 displays the post setting change warning display 102 as shown in FIG. 7 on the display screen 72 of the display unit 68 each time that the time interval determined in advance elapses. FIG. 7 is a diagram showing an example of the post setting change warning display. The post setting change warning display 102 is a warning display at a time after a setting change has been made. The time interval is stored in the time interval storage unit 82 in the manner described above. As shown in FIG. 7, the post setting change warning display 102 may be made up from a pop-up screen, for example, but the present invention is not limited to this feature. In FIG. 7, an example is shown of a case in which a message, “The ‘resistivity alarm is set to ‘warning’. There is a possibility of imparting an adverse effect to the machinery. Should the original setting be restored?” The pop-up screen that makes up the post setting change warning display 102 may include, for example, a YES button 104A on which “YES” is displayed, and a NO button 104B on which “NO” is displayed. In the case that the user has selected the YES button 104A, the original setting is restored. In other words, in the case that the user has selected the YES button 104A, the initial value is restored. In such a case, the setting change unit 65 restores the setting content of the setting item to the setting content corresponding to the initial value. In the case that the user has selected the NO button 104B, the setting content of the setting item is not changed. More specifically, in such a case, the setting change unit 65 maintains the setting content of the setting item as it is. Moreover, in this instance, although a case in which the post setting change warning display 102 is made up from a pop-up screen has been described as an example, the present invention is not limited to this feature.

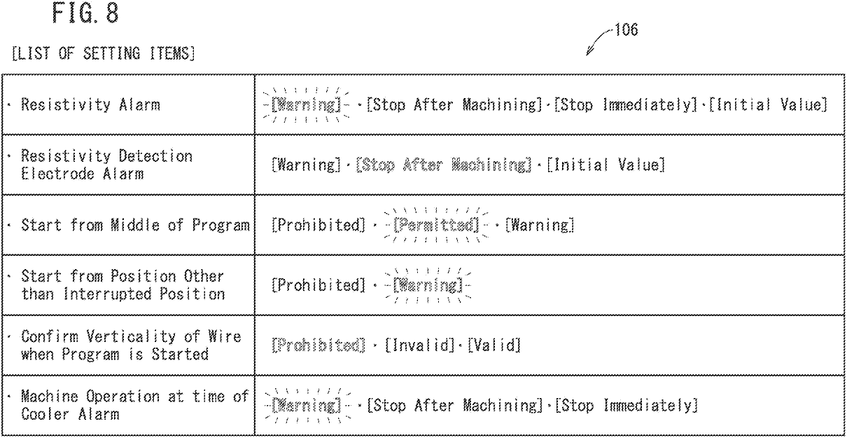

The list screen display control unit 78 is capable of displaying, on the display screen 72 of the display unit 68, a list screen 106 showing a list of a plurality of setting items. FIG. 8 is a diagram showing an example of the list screen. The list screen display control unit 78 enables a display mode of characters indicating the current setting contents to be different from a display mode of characters indicating the setting contents other than the current setting contents. In the example shown in FIG. 8, the current setting contents are indicated in outline characters, and the setting contents other than the current setting contents are indicated by normal characters. It should be noted that the color of the characters indicating the current setting contents and the color of the characters indicating setting contents other than the current setting contents may be made different from each other. The list screen display control unit 78 may cause the setting contents of the setting items for which the risk level is greater than or equal to the warning threshold to be displayed in a flashing manner. As a result, the user is capable of easily grasping the setting contents of the setting items for which the risk level is high.

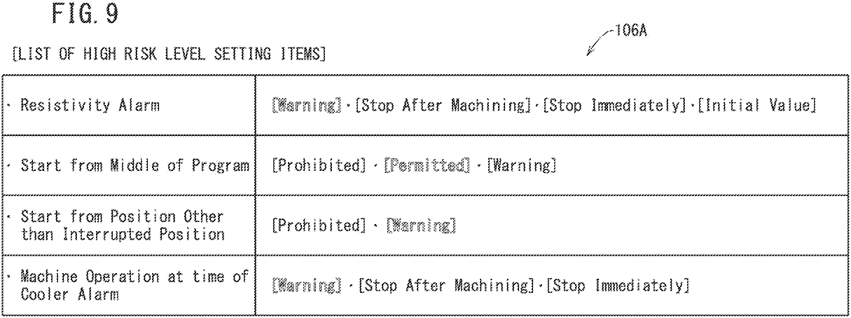

The list screen display control unit 78 is capable of displaying, on the display screen 72 of the display unit 68, a list screen 106A of the setting items for which the risk level is greater than or equal to the warning threshold. FIG. 9 is a diagram showing an example of the list screen. FIG. 9 shows the list screen 106A of the setting items for which the risk level is greater than or equal to the warning threshold. Setting items for which the risk level is less than the warning threshold are not displayed on the list screen 106A. In the example shown in FIG. 9, in the same manner as the example shown in FIG. 8, the current setting contents are indicated in outline characters, and the setting contents other than the current setting contents are indicated by normal characters. In the example shown in FIG. 9, only the setting items for which the risk level is greater than or equal to the warning threshold are displayed in the list. It should be noted that the setting contents of the setting items for which the risk level is greater than or equal to the warning threshold may also be displayed in a flashing manner on the list screen 106A.

As shown in FIG. 2, the controller 18 is capable of communicating with the information management device 88 via the communication unit 86. The information management device 88 manages the information supplied from a plurality of the electrical discharge machines 10. Information for carrying out the post setting change warning display 102 can be transmitted to external equipment 90 via the communication unit 86 and the information management device 88. Further, information for carrying out the display of the list screens 106 and 106A can be transmitted to the external equipment 90 via the communication unit 86 and the information management device 88. As examples of the external equipment 90, there may be cited a mobile terminal, a personal computer, or the like, but the present invention is not limited to such examples. As examples of the mobile terminal, there may be cited a smartphone, a tablet terminal, or the like, but the present invention is not limited to such examples.

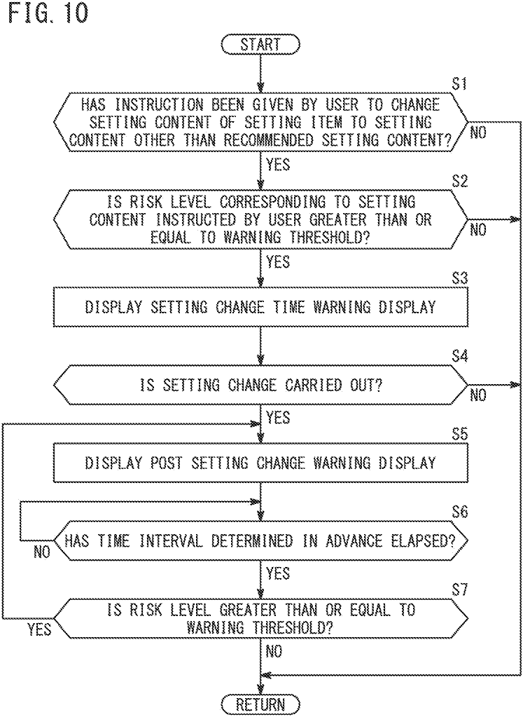

Next, operations of the electrical discharge machine according to the present embodiment will be described with reference to FIG. 10. FIG. 10 is a flowchart showing operations of the electrical discharge machine according to the present embodiment. Operations related to the warning display are shown in FIG. 10.

In step S1, the first determination unit 63 determines whether or not an instruction has been given by the user to change the setting content of any one of a plurality of setting items determined in advance to a setting content other than the recommended setting content. In the case that an instruction has been given by the user to change the setting content of the setting item to a setting content other than the recommended setting content (YES in step S1), the process transitions to step S2. In the case that the setting content of the setting item is set to the recommended setting content (NO in step S1), the process shown in FIG. 10 comes to an end.

In step S2, the first determination unit 63 determines whether or not the risk level corresponding to the setting content instructed by the user is greater than or equal to the warning threshold, based on the risk level corresponding to the setting content of the setting item. Moreover, as discussed previously, the risk levels are stored in the risk level storage unit 80. In the case that the risk level corresponding to the setting content instructed by the user is greater than or equal to the warning threshold (YES in step S2), the process transitions to step S3. In the case that the risk level corresponding to the setting content instructed by the user is less than the warning threshold (NO in step S2), the process shown in FIG. 10 comes to an end.

In step S3, the setting change time display control unit 74 displays the setting change time warning display 98 on the display screen 72 of the display unit 68. Thereafter, the process transitions to step S4.

Even though the setting change time warning display 98 is displayed on the display screen 72 of the display unit 68, in the case that an instruction has been given by the user to carry out such a setting change (YES in step S4), then the setting change unit 65 changes the setting. Thereafter, the process transitions to step S5. In the case that the instruction is given by the user not to change the setting (NO in step S4), the setting change unit 65 does not change the setting. In this case, the process shown in FIG. 10 comes to an end.

In step S5, the post setting change display control unit 76 displays the post setting change warning display 102 on the display screen 72 of the display unit 68. The post setting change display control unit 76 is capable of displaying the post setting change warning display 102 on the display screen 72 of the display unit 68, for example, immediately after an instruction has been given by the user to carry out such a setting change. Moreover, the post setting change warning display 102 may be displayed on the display screen 72 of the display unit 68 after a certain amount of time has elapsed since the instruction has been given by the user to carry out such a setting change. Thereafter, the process transitions to step S6.

In step S6, the second determination unit 64 determines whether or not the time corresponding to the time interval determined in advance has elapsed. In the case that the time corresponding to the time interval determined in advance has elapsed (YES in step S6), the process transitions to step S7. In the case that the time corresponding to the time interval determined in advance has not elapsed (NO in step S6), step S6 is repeated.

In step S7, the second determination unit 64 determines whether or not the risk level corresponding to the current setting content of the setting item is greater than or equal to the warning threshold. In the case that the risk level corresponding to the current setting content of the setting item is greater than or equal to the warning threshold (YES in step S7), the process transitions to step S5. In the case that the risk level corresponding to the current setting content of the setting item is less than the warning threshold (NO in step S7), the process shown in FIG. 10 comes to an end.

In the foregoing manner, in accordance with the present embodiment, in the case that the risk level corresponding to the setting content instructed by the user is greater than or equal to the warning threshold, the setting change time warning display 98 is displayed on the display screen 72 of the display unit 68. Therefore, it is possible to alert the user that the setting change may bring about a high risk. In addition, in accordance with the present embodiment, in the case that the risk level continues to be greater than or equal to the warning threshold even after the setting change time warning display is displayed, the post setting change warning display 102 is displayed on the display screen 72 of the display unit 68 each time that the time interval determined in advance elapses. Therefore, in accordance with the present embodiment, it is possible to prevent the electrical discharge machine 10 from being used continuously in a high risk state.

### (Exemplary Modification)

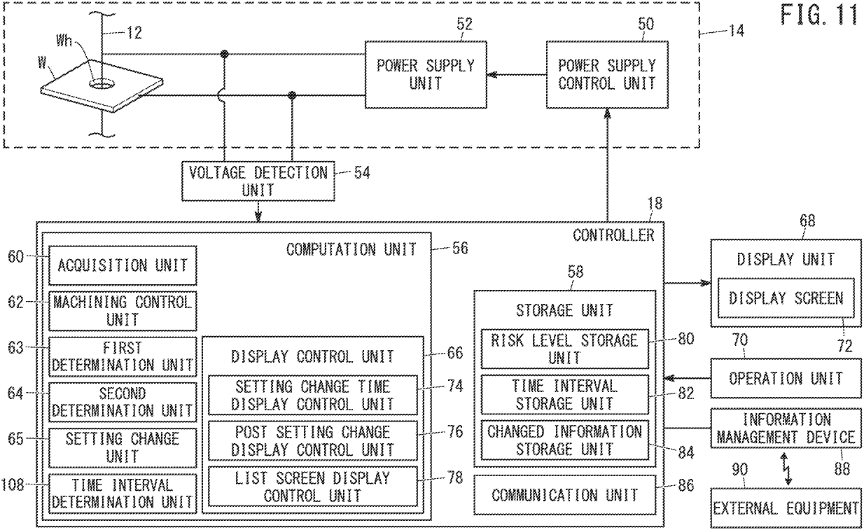

An electrical discharge machine according to an exemplary modification of the present embodiment will be described with reference to FIG. 11. FIG. 11 is a block diagram showing a portion of the electrical discharge machine according to the exemplary modification.

The electrical discharge machine 10 according to the present exemplary modification further includes a time interval determination unit 108 that determines a time interval in accordance with the risk level. In the case that the risk level is relatively high, the time interval determination unit 108 sets the time interval to be relatively short. On the other hand, in the case that the risk level is relatively low, the time interval determination unit 108 sets the time interval to be relatively long. Each time that the time interval determined by the time interval determination unit 108 elapses, the post setting change display control unit 76 displays the post setting change warning display 102 on the display screen 72 of the display unit 68.

In this manner, the time interval determination unit 108 may determine the time interval in accordance with the risk level.

### [Modified Embodiments]

Although a preferred embodiment of the present invention has been described above, the present invention is not limited to the above-described embodiment, and various modifications can be made thereto without departing from the essence and gist of the present invention.

For example, although in the above-described embodiment, a case has been described as an example in which the setting contents of the setting items related to the “machine operations at the time of an alarm” are changed, the present invention is not limited to this feature. More specifically, although in the above-described embodiment, a case has been described as an example in which the setting contents of the setting items related to an alarm are changed, the present invention is not limited to this feature. For example, the present invention may be applied to a situation in which the setting content of the setting item related to the dielectric working fluid is changed. More specifically, when the user carries out an operation that excessively increases or decreases the resistivity of the dielectric working fluid, a warning display may be performed. Further, the present invention may also be applied to a situation in which the setting content of a setting item related to the program, the setting content of a setting item related to editing the program, the setting content of a setting item related to an AI control, the setting content of a setting item related to a taper, or the like, is changed. Further, the present invention may also be applied to a situation in which the setting content of a setting item related to user assistance, the setting content of a setting item related to a wire cutter, the setting content of a setting item related to auto wire feeding, the setting content of a setting item related to a positioning setting, or the like, is changed. Further, the present invention may also be applied to a situation in which the setting content of a setting item related to vertical adjustment, the setting content of a setting item related to a taper guide measurement, the setting content of a setting item related to a filter, or the like, is changed.

Further, although in the above-described embodiment, a case has been described as an example in which the setting change time warning display 98 is displayed on the display screen 72 of the display unit 68 prior to the setting content having been changed by the setting change unit 65, the present invention is not limited to this feature. For example, after the setting content has been changed by the setting change unit 65 based on an instruction from the user, the setting change time warning display 98 may be displayed on the display screen 72 of the display unit 68.

Further, although in the above-described embodiment, a case has been described as an example in which the electrical discharge machine 10 is a wire electrical discharge machine, the present invention is not limited to this feature. The electrical discharge machine 10 may be a die-sinking electrical discharge machine or the like. Such a die-sinking electrical discharge machine is a machine tool that applies a voltage within the dielectric working fluid between an electrode (a tool electrode) that is machined into a shape to be transferred and the object to be machined W, and generates an electrical discharge in a machining gap formed between the tool electrode and the object to be machined W, thereby transferring the shape of the tool electrode to the object to be machined W.

The embodiment described above can be summarized in the following manner.

The electrical discharge machine (10) is characterized by an electrical discharge machine including the controller (18) that carries out electrical discharge machining on the object to be machined by generating an electrical discharge in the machining gap formed between the object to be machined (W) and the electrode (12), the electrical discharge machine comprising the risk level storage unit (80) that stores risk levels corresponding to the setting contents of various setting items of the controller, the first determination unit (63) that determines, in the case that an instruction is given by the user to change the setting content of any one of a plurality of the setting items determined in advance to a setting content other than the recommended setting content, whether or not the risk level corresponding to the setting content instructed by the user is greater than or equal to the warning threshold based on the risk levels stored in the risk level storage unit, the setting change time display control unit (74) that displays, on the display unit (68), the setting change time warning display (98) that is a warning display at the time of setting change, in the case that the first determination unit has determined that the risk level corresponding to the setting content instructed by the user is greater than or equal to the warning threshold, the second determination unit (64) that determines, after the setting change time warning display is displayed, whether or not a state in which the risk level is greater than or equal to the warning threshold is continuing, and the post setting change display control unit (76) that displays, on the display unit and each time that a time interval determined in advance elapses, the post setting change warning display (102) that is a warning display after the setting change has been made, in the case that the second determination unit has determined that the state in which the risk level is greater than or equal to the warning threshold is continuing. In accordance with such a configuration, in the case that the risk level corresponding to the setting content after the setting change has been made is greater than or equal to the warning threshold, the setting change time warning display is displayed on the display unit. Therefore, it is possible to alert the user that the change in the setting content of the setting item may bring about a high risk. In addition, in accordance with such a configuration, even after the setting change time warning display has been displayed, if the risk level continues to be greater than or equal to the warning threshold, the post setting change warning display is displayed on the display unit each time that the time interval determined in advance elapses. Therefore, in accordance with such a configuration, it is possible to prevent the electrical discharge machine from being used continuously in a high risk state.

There may further be provided the setting change unit (65) that changes the setting content of the setting item in the case that an operation to change the setting content of the setting item is performed by the user, wherein, before the setting content is changed by the setting change unit, the setting change time display control unit may display the setting change time warning display on the display unit. In accordance with such a configuration, before the setting content is changed by the setting change unit, it is possible to alert the user that the change in the setting content of the setting item may bring about a high risk.

There may further be provided the time interval storage unit (82) that stores the time interval corresponding to the risk level, wherein, each time that the time interval corresponding to the risk level elapses, the post setting change display control unit may display the post setting change warning display on the display unit. In accordance with such a configuration, it is possible to display the post setting change warning display at appropriate time intervals corresponding to the risk level.

There may further be provided the time interval determination unit (108) that determines the time interval in accordance with the risk level, wherein, each time that the time interval determined by the time interval determination unit in accordance with the risk level elapses, the post setting change display control unit may display the post setting change warning display on the display unit. In accordance with such a configuration, it is possible to display the post setting change warning display at appropriate time intervals corresponding to the risk level.

There may further be provided the list screen display control unit (78) that displays the list screen (106, 106A) of the plurality of setting items. In accordance with such a configuration, the user can confirm the listing of the setting items.

The list screen display control unit may display the list screen of the setting items for which the risk level is greater than or equal to the warning threshold. In accordance with such a configuration, the user can confirm the listing of the setting items for which the risk level is greater than or equal to the warning threshold.

The list screen display control unit may cause the setting contents of the setting items for which the risk level is greater than or equal to the warning threshold to be displayed in a flashing manner. In accordance with such a configuration, the user can easily grasp the setting contents for which the risk level is high.

There may further be provided the changed information storage unit (84) that stores information indicative of the time of the setting change, the setting items for which the setting change has been made, and the content of the setting change. In accordance with such a configuration, it is possible to confirm a history of the changes.

There may further be provided the communication unit (86) that communicates with the information management device (88), wherein the post setting change display control unit may supply the information for displaying the post setting change warning display on the external equipment (90), to the external equipment via the communication unit and the information management device. In accordance with such a configuration, the post setting change warning display can be displayed on the external equipment.

There may further be provided the communication unit that communicates with the information management device, wherein the list screen display control unit may supply the information for displaying the list screen on the external equipment, to the external equipment via the communication unit and the information management device. In accordance with such a configuration, the list screen can be displayed on the external equipment.

The external equipment may be a mobile terminal or a personal computer.

The plurality of setting items determined in advance may include any one from among: a setting item related to an operation when the resistivity alarm, which is an alarm issued when the resistivity of the dielectric working fluid lies outside of the recommended range, is issued; a setting item related to an operation when the resistivity detection electrode alarm is issued, the resistivity detection electrode alarm being an alarm issued when a maintenance deadline for the resistivity detection electrode, which is an electrode for detecting the resistivity of the dielectric working fluid, has expired; a setting item related to an operation when the start key is pressed in a state in which the cursor is positioned at a position other than the beginning of the program; a setting item related to restarting of the electrical discharge machining in the case that the start key is pressed in a state in which a position other than the machining interrupted position is the machining restarting position; a setting item related to confirming whether or not the electrode is positioned in the vertical position registered in advance as the initial position; and a setting item related to an operation when the cooler alarm, which is an alarm issued when a malfunction has occurred in the cooler for cooling the dielectric working fluid, is issued.

1. An electrical discharge machine including a controller configured to carry out electrical discharge machining on an object to be machined by generating an electrical discharge in a machining gap formed between the object to be machined and an electrode, the electrical discharge machine comprising:
a risk level storage unit configured to store risk levels corresponding to setting contents of various setting items of the controller;
a first determination unit configured to determine, in a case that an instruction is given by a user to change a setting content of any one of a plurality of the setting items determined in advance to a setting content other than a recommended setting content, whether or not the risk level corresponding to the setting content instructed by the user is greater than or equal to a warning threshold based on the risk levels stored in the risk level storage unit;
a setting change time display control unit configured to display, on a display unit, a setting change time warning display that is a warning display at a time of setting change, in a case that the first determination unit has determined that the risk level corresponding to the setting content instructed by the user is greater than or equal to the warning threshold;
a second determination unit configured to determine, after the setting change time warning display is displayed, whether or not a state in which the risk level is greater than or equal to the warning threshold is continuing; and
a post setting change display control unit configured to display, on the display unit and each time that a time interval determined in advance elapses, a post setting change warning display that is a warning display after the setting change has been made, in a case that the second determination unit has determined that the state in which the risk level is greater than or equal to the warning threshold is continuing.

2. The electrical discharge machine according to claim 1, further comprising a setting change unit configured to change the setting content of the setting item in a case that an operation to change the setting content of the setting item is performed by the user,
wherein, before the setting content is changed by the setting change unit, the setting change time display control unit displays the setting change time warning display on the display unit.

3. The electrical discharge machine according to claim 1, further comprising a time interval storage unit configured to store the time interval corresponding to the risk level,
wherein, each time that the time interval corresponding to the risk level elapses, the post setting change display control unit displays the post setting change warning display on the display unit.

4. The electrical discharge machine according to claim 1, further comprising a time interval determination unit configured to determine the time interval in accordance with the risk level,
wherein, each time that the time interval determined by the time interval determination unit in accordance with the risk level elapses, the post setting change display control unit displays the post setting change warning display on the display unit.

5. The electrical discharge machine according to claim 1, further comprising a list screen display control unit configured to display a list screen of the plurality of setting items.

6. The electrical discharge machine according to claim 5, wherein the list screen display control unit displays the list screen of the setting items for which the risk level is greater than or equal to the warning threshold.

7. The electrical discharge machine according to claim 5, wherein the list screen display control unit causes the setting contents of the setting items for which the risk level is greater than or equal to the warning threshold to be displayed in a flashing manner.

8. The electrical discharge machine according to claim 1, further comprising a changed information storage unit configured to store information indicative of a time of the setting change, the setting items for which the setting change has been made, and a content of the setting change.

9. The electrical discharge machine according to claim 1, further comprising a communication unit configured to communicate with an information management device,
wherein the post setting change display control unit supplies information for displaying the post setting change warning display on external equipment, to the external equipment via the communication unit and the information management device.

10. The electrical discharge machine according to claim 5, further comprising a communication unit configured to communicate with an information management device,
wherein the list screen display control unit supplies information for displaying the list screen on external equipment, to the external equipment via the communication unit and the information management device.

11. The electrical discharge machine according to claim 9, wherein the external equipment is a mobile terminal or a personal computer.

12. The electrical discharge machine according to claim 1, wherein the plurality of setting items determined in advance include any one from among: a setting item related to an operation when a resistivity alarm is issued, the resistivity alarm being an alarm issued when a resistivity of a dielectric working fluid lies outside of a recommended range; a setting item related to an operation when a resistivity detection electrode alarm is issued, the resistivity detection electrode alarm being an alarm issued when a maintenance deadline for a resistivity detection electrode, which is an electrode configured to detect the resistivity of the dielectric working fluid, has expired; a setting item related to an operation when a start key is pressed in a state in which a cursor is positioned at a position other than a beginning of a program; a setting item related to restarting of the electrical discharge machining in a case that the start key is pressed in a state in which a position other than a machining interrupted position is a machining restarting position; a setting item related to confirming whether or not the electrode is positioned in a vertical position registered in advance as an initial position; and a setting item related to an operation when a cooler alarm is issued, the cooler alarm being an alarm issued when a malfunction has occurred in a cooler configured to cool the dielectric working fluid.
